(19) United States
(12) Patent Application Publication
(10) Pub. No.: US 2007/0039875 A1
(43) Pub. Date: Feb. 22, 2007

(54) Absorbent article

(76) Inventors: Deena Solomon-Winnemore, Santa Monica, CA (US); Paul Lee Winnemore, Santa Monica, CA (US)

Correspondence Address: David O. Simmons;Galasso & Associates LP, P.O. Box 26503, Austin, TX, 78755-0503, US

(21) Appl. No.: 11/210,123

(22) Filed: Aug. 22, 2005

(51) Int. Cl. B01D 39/00

(52) U.S. Cl. 210/502.1; 99/485; 99/497; 206/204

(57) ABSTRACT

An article is used to preferentially absorb fats and oils and the like from food. The article comprises an absorbent article including a non-absorbent backing, a layer of absorbent material and a container. The layer of absorbent material is attached to the non-absorbent backing. The container is used for containment and disposal of the absorbent article before and/or after use.

### FIELD OF THE DISCLOSURE

The disclosures made herein relate generally to a highly absorbent material that is used to soak up fat and oil from items of food. More particularly, the present invention provides an oil absorbent article, including a non-absorbent protective material and a layer of absorbent material attached to the non-absorbent protective material, which is conveniently packaged in its own sealable and/or disposable container.

### BACKGROUND

The increase of information regarding the deleterious effects of excess fat and fatty foods on the human body has made consumers increasingly conscious of their eating habits. More aware of problem foods they try to minimize the amount of fat or oils contained in their diets.

Previous attempts to remove quantities of fats and oils from food include those disclosed in U.S. Pat. No. 5,744,406, describing a method for removing any single component or mixture of fats, oils and greases which have been added to or rendered out of an animal or vegetable product during cooking. The method uses a microwave-safe, biodegradable product that nearly instantaneously absorbs fats, oils and greases onto a fabric substrate that is hydrophobic for water repellency and oleophilic or oil attracting. U.S. Pat. No. 5,814,396 uses an oil absorbing fabric in the form of a disposable three-layer pad for collecting cooking grease while covering a substantial portion of the bottom cooking area of a microwave oven. The top layer of the pad comprises at least one ply of a grease absorptive sheet. The middle layer is a grease resistant sheet and the bottom layer is an anti-stick insulating sheet preventing attachment of the pad to the floor of the microwave oven

U.S. Pat. No. 6,578,285 describes a range of food types and devices and methods for reducing fat calories from the various types of food. This patent further discloses a device for absorbing or blotting grease from the surface of foods such as pizza. The device comprises a support member having a handle for manually gripping the device and an absorbent pad attached to such support member for blotting the surface of a food item.

Addressing a different aspect of oil removal, U.S. Pat. No. 6,152,025 discloses a structure and method for absorbing excess fat from an environment including one or more fats insolubly combined in an aqueous solution mix. A plurality of layers provides the absorbent structure that has at least one layer formed from a preferentially fat-permeable, oleophilic material having a greater affinity for fat than for the aqueous solution. The absorption structure submerged in a fluid form of food that has fat mixed with water, such as a soup, broth, etc., attracts and absorbs at least a portion of the fat from the mixture.

A readily available, easily disposable article reminding consumers to limit fat in their diet and providing a simple way to do so, would be useful, advantageous and novel.

### SUMMARY OF THE DISCLOSURE

Embodiments of an absorbent article that is used to soak up fat and oil from almost any food in accordance with the present invention provide a number of benefits including convenient use and easy disposal. More specifically, embodiments of the present invention allow a person to eat foods made healthier and lighter using a readily disposable article to reduce the amount of ingested fat normally associated with consuming those foods.

One object of the present invention is to provide a person with a healthier diet by cutting calories from food regardless of the food being eaten.

Also, an object of the present invention is to allow a person to lose weight over time by cutting the fat in foods that the person would normally eat.

Another object of the present invention is the removal of oil, grease and fat from foods that cause weight gain and have an adverse effect upon the health of those ingesting such materials. A savings of one tablespoon of oil per day, for example, represents a reduction of 120 calories of fat per day or consumption of twelve pounds less per year.

For convenience, an object of the present invention is to provide a highly absorbent sheet that is used to soak up fat and oil from almost any type of food. A thin piece of material, applied to a food item for a few seconds, absorbs much of the fat, grease, and oil that form a coating on the surface of the food. Absorbent material in accordance with the present invention removes harmful and calorie-ridden oil and fat from foods such as grilled steak and pizza and the like.

Considering the ease of use of an oil absorbing material, it is an object of the present invention to provide a simple product conveniently packaged in its own sealable container, also referred to herein as a disposable pouch or bag. The packaged product has a size that fits easily in a purse or pocket so that it is readily available during meals.

Turning now to specific aspects of the present invention, in at least one embodiment the present invention provides a sheet of material that is used to soak up fat and oil from almost any food. The sheet comprises a dual layer structure having an absorbent layer on one side for soaking up oil and fat. On the other side of the sheet, a layer of non-absorbent backing protects a person's hands from the oil held in the absorbent layer following removal of oil or grease from an item of food. As appropriate the sheet in accordance with the present invention contains other functional layers.

Having described the basic construction of an oil absorbent sheet in accordance with the present invention, the inclusion of additional features results in a variety of optional useful embodiments as follows:

In at least one embodiment of the sheet of the present invention, the absorbent layer is made from an oleophilic material including special paper materials and other known materials having a greater attraction affinity for fat than for non-fat food components. Preferably, the absorbent layer is hydrophobic as well as oleophilic, thus preferentially attracting and absorbing fat rather than aqueous components of food items. It is also desirable for the layer of absorbent to include topographical features and internal pockets which increase the absorptive surface area that would otherwise be available in absorbent layer of a given size.

At least one embodiment of the present invention provides a sheet of oil absorbent product in its own sealable container that prevents contamination of the sheet before use and facilitates disposal of an oil-soaked sheet after use. Suitable containers include bags and pouches having sealable closures.

In at least one embodiment in accordance with the present invention, an oil absorbent sheet attaches to the inside of its sealable container is such a fashion that it may be withdrawn from the container for application to a food item but cannot be fully removed from the container.

More particularly an article in accordance with the present invention has been described as an article to reduce ingestion of dietary fats. The article comprises a sealed container having an absorbent article contained therein.

Additional detail reveals an article to reduce ingestion of dietary fats, wherein the article comprises an absorbent article and a sealable pouch integrally attached to the absorbent article.

Further, the present invention provides an article to reduce ingestion of dietary fats from items of food, wherein the article comprises a pouch having a first face and a second face and an absorbent article attached to the first face and releasable from the second face to expose absorbent material for absorption of dietary fats from items of food to reduce ingestion of dietary fats.

The most general form of an article in accordance with the present invention is a device for absorbing fats, greases, and oils, comprising a sealed container having an absorbent article contained therein.

An article in accordance with the present invention is also a grease-blotting device for removing grease and oil from the surface of a recently cooked food item. The device comprises an absorbent article for contacting the food item and a sealable pouch integrally attached to the absorbent article.

For use in an environment including one or more fats insolubly deposited on an item of food, a structure adapted to preferentially absorb the fats from the food, comprises an absorbent article and a container used for containment and disposal of the absorbent article.

One embodiment of the structure to preferentially absorb fats from food includes the absorbent article having a plurality of layers. The absorbent article typically has a layer of absorbent material on one side to soak up the fats and a non-absorbent backing to prevent oil getting on a user's hands. A layer of absorbent material in accordance with the present invention includes an embossed surface and optionally has a shape selected from the group consisting of circles, ovals, squares and rectangles and combinations thereof. The preferred length and width dimensions of the absorbent article are less than about six inches when contained inside the container.

In a preferred embodiment, the container used for containment and disposal of the absorbent article is sealable using an interlocking closure.

The present invention also includes a method of providing a structure for use in an environment including one or more fats insolubly deposited on an item of food, the method comprising manufacturing an absorbent article to be placed in contact with the item of food to soak and absorb much of the one or more fats deposited thereon, wherein the absorbent article is supplied residing inside a container for withdrawal therefrom to be placed in contact with the item of food.

These and other objects, embodiments, methods, advantages and/or distinctions ofthe present invention will become readily apparent upon further review of the following specification and associated drawings.

### BRIEF DESCRIPTION OF THE DRAWINGS

The invention will now be described in greater detail in the following way of example only and with reference to the attached drawings, in which:

FIG. 1 is a partially cutaway perspective view depicting an oil absorbent article in accordance with an embodiment of the inventive disclosures made herein.

FIG. 2 is an exemplary perspective view of the absorbent article depicted in FIG. 1 being used for removing undesirable substances from a top surface of a slice of pizza.

FIG. 3 is a cross-sectional view of a first embodiment of a packaged absorbent article in accordance with the present invention.

FIG. 4 is a cross-sectional view depicting a second embodiment of a packaged absorbent article in accordance with the present invention.

FIG. 5 is a cross-sectional view depicting a self-containable absorbent article assembly in accordance with the present invention.

### DETAILED DESCRIPTION OF THE DRAWING FIGURES

As required, detailed embodiments of the present invention are disclosed herein; however, it is to be understood that the disclosed embodiments are merely exemplary of the invention that may be embodied in various and alternative forms. The figures are not necessarily to scale and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Current lifestyle trends encourage consumption of low-fat food products designed to improve a person's health and lower their weight. Low-fat food products often fail to meet a consumer's needs for taste and texture. As a result, the goal of improved health is overlooked along with the rejection of bland foods. The lack of interest in low fat recipes suggests the need for an alternative approach for removing fat from food but substantially retaining its flavor.

The goal of flavor retention and fat reduction is achievable in accordance with the present invention using material that absorbs surface oil, grease and fat from food items, regardless of the food eaten. After applying articles in accordance with the present invention to items of food, less fat enters a person's digestive system during consumption of the treated food. The result is a healthier diet without compromising on flavor and dining satisfaction.

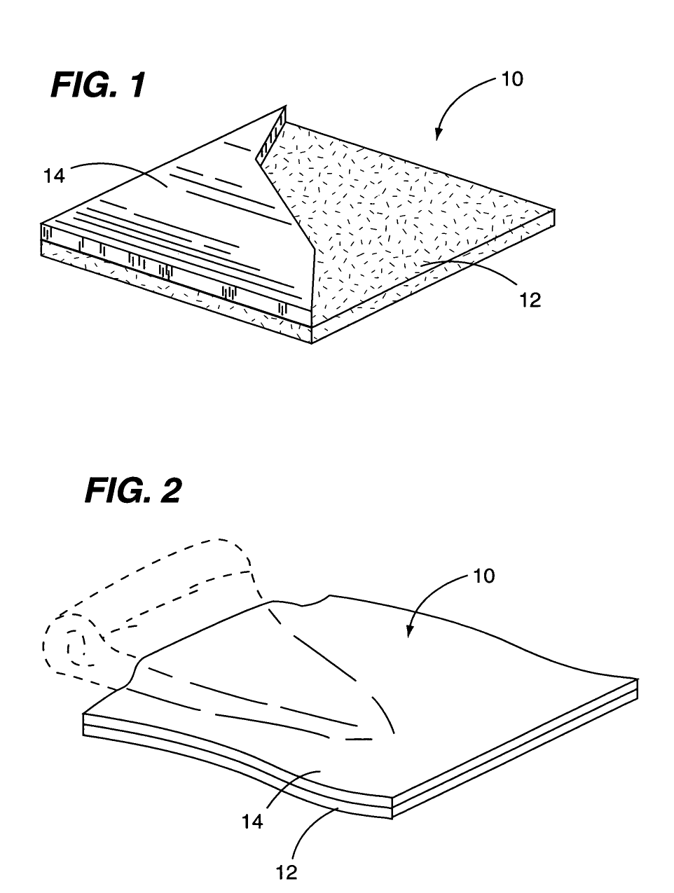

Referring to the figures, wherein like numbers refer to like parts throughout the several views, FIG. 1 depicts an embodiment of an absorbent article in accordance with the present invention, which is referred to herein as the absorbent article 10. The absorbent article 10 includes a layer of absorbent material 12 and a non-absorbent backing 14. Suitable materials for use in the layer of absorbent material 12 include special papers and similar known fibrous structures having affinity for oils, greases and fats (i.e., undesirable substances), which rapidly soak into the layer of absorbent material 12 when in contact with the oil-absorbing and/or trapping fibers of the layer of absorbent material 12 (e.g., oleophilic fibers).

The non-absorbent backing 14 limits the potential for absorbed substances getting on the hands of a person using the absorbent article 10 to remove oil and fat deposits from food, thus serving as a protective layer with respect to substances absorbed. The non-absorbent backing 14 is shown cut away in FIG. 1 to reveal the underlying layer of absorbent material 12. It will be appreciated that a plurality of absorbent layers of material may be implemented and that the non-absorbent backing may include one or more layers of material (e.g., a layer of polymeric film laminated to a layer of metallic foil).

FIG. 2 provides an example of the use of the absorbent article 10 for removing excess oil and grease from the surface of a slice of pizza. As illustrated, the absorbent article 10 has been laid over the slice of pizza so that the layer of absorbent material 12 has contact with the recently cooked food item to soak up grease, oil and molten surface fats. The non-absorbing backing 14 prevents transfer of greasy fat deposits from the layer of absorbent material 12 to a person's hands during removal ofthe absorbent article 10 from the slice of pizza, after it has become contaminated with fat and grease.

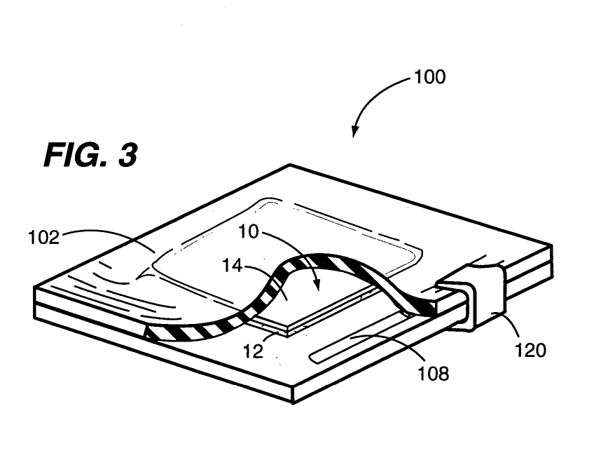

FIG. 3 depicts a first embodiment of a packaged absorbent article in accordance with the present invention, which is referred to herein as the packaged absorbent article 100. The packaged absorbent article includes a container 102 has the absorbent article 10 depicted in FIG. 1 contained therein. The container 102 is partially cut away to provide detail of the absorbent article 10 contained therein. In at least one embodiment in accordance with the present invention, the absorbent article 10 is at least partially attached to the container 102 before and after use. The container 102 is sealable, to protect the layer of absorbent material 12 from contamination before use, and to provide for safe disposal of the absorbent article 10 after use, when it has become contaminated by oil and fat. A closure 108, such as an interlocking closure, provides a suitable means to ensure that the container 102 is sealable. It is possible that packages, having closures 108, including an interlocking mechanism, also use a slider 120 similar to those included in well known Ziploc® brand baggies, for example, but other types of closures are suitable for use in accordance with the present invention.

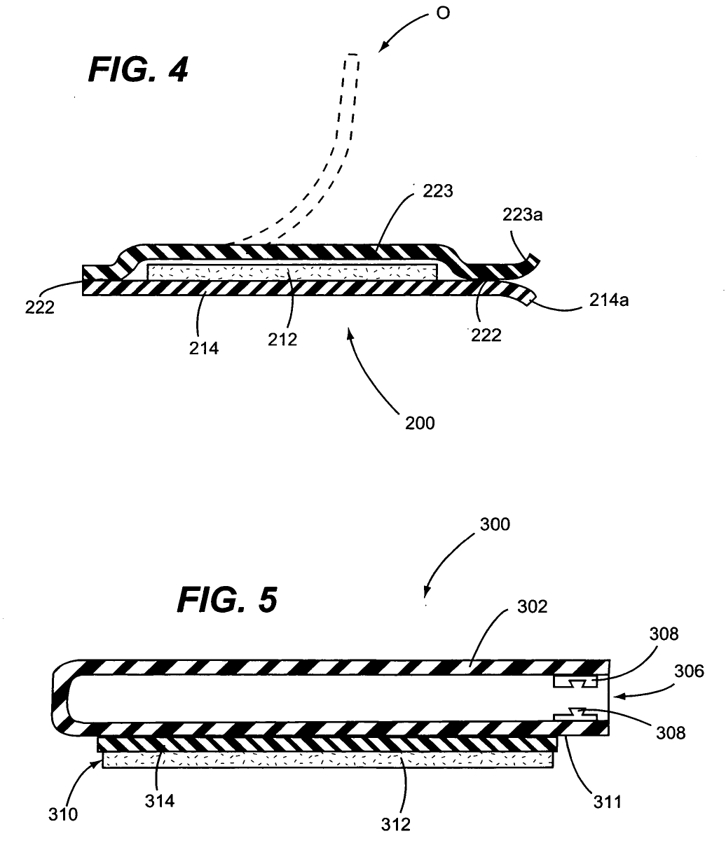

FIG. 4 depicts a second embodiment of a packaged absorbent article in accordance with the present invention, which is referred to herein as the packaged absorbent article 200. The packaged absorbent article 200 includes an absorbent article 210 that has a layer of absorbent material 212 attached to a non-absorbent backing 214. The non-absorbent backing 214 extends outward from the edges of the layer of absorbent material 212 providing a surface for forming a seal 222 with a releasable cover sheet 223. Preferably, but not necessarily, the releasable cover sheet 223 is releasably sealed with the non-absorbent backing 214 around an entire perimeter of the layer of absorbent material 212. The releasable cover sheet 223 and the non-absorbent backing 214 include respective graspable tab portions (223a, 214a) for enabling the releasable cover sheet 223 and the non-absorbent backing 214 to be individually grasped for separating the cover sheet 223 from the non-absorbent backing 214. With the releasable cover sheet 223 at least partially separated from the non-absorbent backing 214, the layer of absorbent material 212 is accessible for use. The releasable cover sheet 223 encloses the layer of absorbent material 12, but is easily folded back by gripping the respective graspable tab portions (223a, 214a), breaking the seal 222 and peeling back the releasable cover sheet 223 to an open position O to expose the layer of absorbent material 212. The releasable cover sheet 223, the seal 222 and the non-absorbent backing 214 may be jointly configured for enabling the releasable cover sheet to be partially released from or, optionally, entirely removed from the non-absorbent backing 214.

FIG. 5 depicts a self-containable absorbent article assembly in accordance with the present invention, which is referred to herein as the self-containable absorbent article assembly 300. The self-containable absorbent article assembly 300 includes a plastic bag 302 (i.e., a container) and an absorbent article 310. The absorbent article 310 is substantially the same as the absorbent article 10 disclosed in reference to FIG. 1.

The plastic bag 302 has an opening 306 at an end thereof and a mating closure features 308 for enabling the opening 306 of the plastic bag 302 in a substantially sealed-closed position. The absorbent article 310 is attached to an exterior surface 311 of the plastic bag 302. The absorbent article 310 includes a layer of absorbent material 312 and a non-absorbent backing 314 attached to the layer of absorbent material 312. The non-absorbent backing 314 is fixedlyorreleasably attached to the exterior surface 311 of the plastic bag 302.

A conveniently packaged product has a size allowing easy carrying, preferably by fitting into a user's pocket or purse. A preferred container size has a major dimension less than about six inches. The desired size will be controlled by the size of the container but the size of the absorbent article is variable provided it is folded to meet the limiting dimension when placed inside the sealable container. As a further option, the absorbent article could be made available in different shapes and sizes.

An absorbent article in accordance with the present invention finds use during preparation or consumption of items of food to absorb oil present on the surface of the food. When laid on a food item for a few seconds, the layer of absorbent material soaks up much of the surface fat and grease and oil. In this way the layer of absorbent material removes oil or fat from grilled steaks, slices of pizza, hamburgers, and fried sausages and the like, for example.

Used with soup, an absorbent article in accordance with the present invention is effective for blotting up surface oil that separates from the water-based portion of the soup. After use to remove fat, grease and oil from foodstuffs, an absorbent article in accordance with the present invention is sealed back inside its pouch for safe disposal such as in a trash container.

An absorbent article that absorbs oil, grease and fat has the advantage of making desired food healthier to eat and doing this without noticeably affecting or otherwise changing the food's flavor. Removal of oil and fat from food reduces the number of calories a person consumes as harmful fat calories. The small amount of effort required to remove the fat calories leads, over time, to added benefits of a healthier diet and possible loss of weight. It is believed that one tablespoon of oil removed from food items each day represents elimination of 120 fat calories from a daily diet. This represents a reduction of twelve pounds of fat consumed each year.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice embodiments ofthe present invention. It is to be understood that other suitable embodiments may be utilized and that logical, mechanical, chemical and electrical changes may be made without departing from the spirit or scope of the present invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A packaged absorbent article, comprising:
a container; and
an absorbent article removable contained within a cavity of the container, wherein the absorbent article is accessible through the opening of the container and wherein the absorbent article includes a layer of absorbent material attached to a non-absorbent backing.

2. The packaged absorbent article of claim 1 wherein the layer of absorbent material includes fibers specifically configured for absorbing at least one of oil, fatty substances and greasy substances.

3. The packaged absorbent article of claim 1 wherein the absorbent article is at least partially attached to the container within the cavity.

4. The packaged absorbent article of claim 3 wherein the layer of absorbent material includes fibers specifically configured for absorbing at least one of oil, fatty substances and greasy substances.

5. The packaged absorbent article of claim 1 wherein:
the container is a plastic bag; and
the layer of absorbent material includes fibers specifically configured for absorbing at least one of oil, fatty substances and greasy substances.

6. A packaged absorbent article, comprising:
an absorbent article including a layer of absorbent material attached to a non-absorbent backing; and
a cover sheet releasably attached to the non-absorbent backing over the absorbent material.

7. The packaged absorbent article of claim 6 wherein the cover sheet is attached to the non-absorbent backing in a manner providing a seal around an entire perimeter of the layer of absorbent material.

8. The packaged absorbent article of claim 7 wherein the layer of absorbent material includes fibers specifically configured for absorbing at least one of oil, fatty substances and greasy substances.

9. The packaged absorbent article of claim 6 wherein the cover sheet and the non-absorbent backing include respective graspable tab portions for enabling the cover sheet and the non-absorbent layer to be grasped to at least partially release the cover sheet from the non-absorbent backing.

10. The packaged absorbent article of claim 9 wherein the cover sheet is attached to the non-absorbent backing in a manner providing a seal around an entire perimeter of the layer of absorbent material.

11. The packaged absorbent article of claim 10 wherein the layer of absorbent material includes fibers specifically configured for absorbing at least one of oil, fatty substances and greasy substances.

12. A self-containable absorbent article assembly, comprising:
a plastic bag having an opening at an end thereof; and
an absorbent article attached to an exterior surface of the plastic bag, wherein the absorbent article includes a layer of absorbent material.

13. The self-containable absorbent article assembly of claim 12 wherein the absorbent article further includes a non-absorbent backing attached between the plastic bag and the layer of absorbent material.

14. The self-containable absorbent article assembly of claim 13 wherein the non-absorbent backing is one of releasably attached to the plastic bag and fixedly attached to the plastic bag.

15. The self-containable absorbent article assembly of claim 14 wherein the layer of absorbent material includes fibers specifically configured for absorbing at least one of oil, fatty substances and greasy substances.

16. The self-containable absorbent article assembly of claim 12 wherein the layer of absorbent material includes fibers specifically configured for absorbing at least one of oil, fatty substances and greasy substances.
